(19) United States
(12) Patent Application Publication
(10) Pub. No.: US 2024/0238155 A1
(43) Pub. Date: Jul. 18, 2024

(54) MASSAGE DEVICE WITH VIBRATION, STRETCHING, AND SWINGING FUNCTIONS

(71) Applicant: Jingkun Huang, Guigang (CN)

(72) Inventor: Jingkun Huang, Guigang (CN)

(21) Appl. No.: 18/624,146

(22) Filed: Apr. 2, 2024

(51) Int. Cl. A61H 19/00; A61H 23/02

(52) U.S. Cl. CPC A61H 19/34; A61H 23/0254; A61H 2201/1481; A61H 2201/169

(57) ABSTRACT

The present disclosure discloses a massage device with vibration, stretching, and swinging functions, and relates to the field of nursing appliances. The massage device includes a shell; one end of the shell is fixedly provided with a soft simulation member; a vibration motor is fixedly mounted on the swinging member; a mounting slot is formed in the middle of one side of the soft simulation member close to the shell; and the vibration motor is fixedly mounted in the mounting slot. Compared with an existing product, the massage device of the present disclosure can move in a manner of stretching, swinging, and vibration, has a better user experience, and has a simple structure and low design cost.

### TECHNICAL FIELD

The present disclosure relates to the field of nursing appliances, and in particular, to a massage device with vibration, stretching, and swinging functions.

### BACKGROUND

Massage is a therapy that combines the theory of internal organs and meridians in traditional Chinese medicine with the anatomical and pathological diagnosis of western medicine. During massage, specific parts of a body surface are massaged to regulate the physiological and pathological conditions of the body and achieve the purpose of physical therapy. In nature, massage is a physical therapy. In terms of treatment, massage can be divided into health-care massage, sports massage, and medical massage.

In health-care massage, a masturbator is a device that massages a private area. This device can be used for women with sexual dysfunction, such as sexual apathy and anorgasmia. This device can also be used for postpartum care and postpartum repair of women. It is a common product on the market. After the traditional masturbator is turned on, a stretchable rotating movement may stretch and rotate. The traditional masturbator is complex in structure and design and high in cost, has the problem of difficulty in production, and has low yield. In the prior art, the conventional masturbator cannot achieve integration of stretching, vibration, and swinging, so that the conventional masturbator has a poor massage effect and will severely affect the postpartum care and postpartum repair effects.

### SUMMARY

In order to overcome the drawbacks described above, the present disclosure provides a technical solution capable of solving the above problems.

A massage device with vibration, stretching, and swinging functions includes a shell, wherein one end of the shell is fixedly provided with a soft simulation member;
a battery, a stretching motor component, a Printed Circuit Board (PCB), and a swinging device are fixedly mounted inside the shell;
the swinging device includes a connector, a swinging member, a rivet shaft, and a guide rail shaft; the connector is fixedly mounted at an output shaft of the stretching motor component through a screw; the swinging member is mounted on the connector through the rivet shaft in a running fit manner; the guide rail shaft is fixedly mounted on the swinging member; guide rail slots are formed in two sides in the shell; two ends of the guide rail shaft are respectively mounted in the guide rail slots in a sliding fit manner;
a vibration motor is fixedly mounted at one end of the swinging member away from the connector; a mounting slot is formed in the middle of one side of the soft simulation member close to the shell; the vibration motor is fixedly mounted in the mounting slot; and
the battery controls the stretching motor component and the vibration motor to work through the PCB.

Further, the two guide rail slots in the shell are symmetrically arranged with each other; the two guide rail slots are of wavy structures; and the swinging member swings up and down through cooperation of the guide rail shaft in the guide rail slots.

Further, the shell includes a first hard inner shell, a second hard inner shell, and a soft outer skin; the first hard inner shell and the second hard inner shell are mounted and fixed by screws; and the soft outer skin is covered and mounted at outer sides of the first hard inner shell and the second hard inner shell.

Further, the PCB is embedded with one or more control buttons; one or more avoidance slots are formed in the first hard inner shell and the second hard inner shell; the control buttons are arranged in the avoidance slots in a one-to-one correspondence and clearance fit manner; and the soft outer skin is arranged in a manner of covering the avoidance slots.

Further, the soft outer skin is made of solid silica gel.

Further, one or more anti-skid edges are formed on an outer side of the soft outer skin.

Further, a hard reinforcing member is arranged on one side of the soft simulation member close to the shell, and the hard reinforcing member is fixedly mounted between the shell and the soft simulation member.

Further, a decorative ring is sleeved and mounted on an outer side of the hard reinforcing member, and the decorative ring is matched and mounted between the shell and the soft simulation member.

Further, a magnetic charging component is embedded on the shell, and the magnetic charging component charges the battery through the PCB.

Further, a motor slot is formed at one end of the swinging member away from the connector; the vibration motor is fixedly mounted in the motor slot; an end cover is fixedly mounted at an end portion of the swinging member; the end cover covers the vibration motor in the motor slot; and one end of the swinging member away from the connector and the end cover are both mounted in the mounting slot of the soft simulation member in a clearance fit manner.

Compared with the prior art, the present disclosure has the beneficial effects: The soft simulation member can integrate swinging, stretching, and vibration to ensure the massage experience of the device. The massage device can be used for women with sexual dysfunction, such as sexual apathy and anorgasmia and can also be used for postpartum care and postpartum repair of women. Compared with the existing product, the massage device has a better use experience and has a simple structure and low design cost, and the production efficiency and production yield of the product are improved.

The additional aspects and advantages of the present disclosure will be partially provided in the following descriptions, some of which will become apparent from the following descriptions, or learned through the practice of the present disclosure.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic diagram of a main view structure of the present disclosure;

FIG. 2 is a schematic diagram of a section structure of the present disclosure;

FIG. 3 is a schematic diagram of an explode structure of the present disclosure;

FIG. 4 is a schematic structural diagram after a soft outer skin is hidden according to the present disclosure;

FIG. 5 is a schematic diagram of an exploded structure of FIG. 4;

FIG. 6 is a schematic structural diagram of a swinging device; and

FIG. 7 is a schematic diagram of an exploded structure of FIG. 6.

In the drawings: 1: soft outer skin; 2: soft simulation member; 3: hard reinforcing member; 4: decorative ring; 5: first hard inner shell; 6: second hard inner shell; 7: guide rail slot; 8: PCB; 9: magnetic charging component; 10: battery; 11: stretching motor component; 12: connector; 13: mounting slot; 14: rivet shaft; 15: swinging member; 16: guide rail shaft; 17: vibration motor; 18: end cover; 19: control button; 20: avoidance slot; 21: antiskid edge; 22: motor slot; and 23: swinging device.

### DETAILED DESCRIPTION OF THE EMBODIMENTS

The technical solutions of the present disclosure are clearly and completely described below in conjunction with the accompanying drawings. Apparently, the described embodiments are some embodiments of the present disclosure, rather than all of the embodiments.

Components of the embodiments of the present disclosure commonly described and shown in the accompanying drawings here may be arranged and designed in a variety of different configurations. Therefore, the following detailed descriptions of the embodiments of the present disclosure provided in the accompanying drawings are not intended to limit the scope of the claimed present disclosure, but merely represents selected embodiments of the present disclosure.

All other embodiments obtained by a person of ordinary skill in the art based on the embodiments of the present disclosure without making creative efforts shall fall within the protection scope of the present disclosure.

In the descriptions of the present disclosure, it should be noted that orientations or positional relationships indicated by the terms “center”, “upper”, “lower”, “left”, “right”, “vertical”, “horizontal”, “inner”, “outer”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure. In addition, the terms “first”, “second”, and “third” are only for the purpose of description, and may not be understood as indicating or implying the relative importance.

In the description of the present disclosure, it should be noted that unless otherwise specified and limited, the terms “mount”, “connect”, and “connection” should be broadly understood. For example, it can be a fixed connection, detachable connection, integrated connection, mechanical connection, electrical connection, direct connection, indirect connection via an intermediate element, or internal communication between two elements. For those of ordinary skill in the art, the specific meanings of the aforementioned terms in the present disclosure can be understood based on specific conditions.

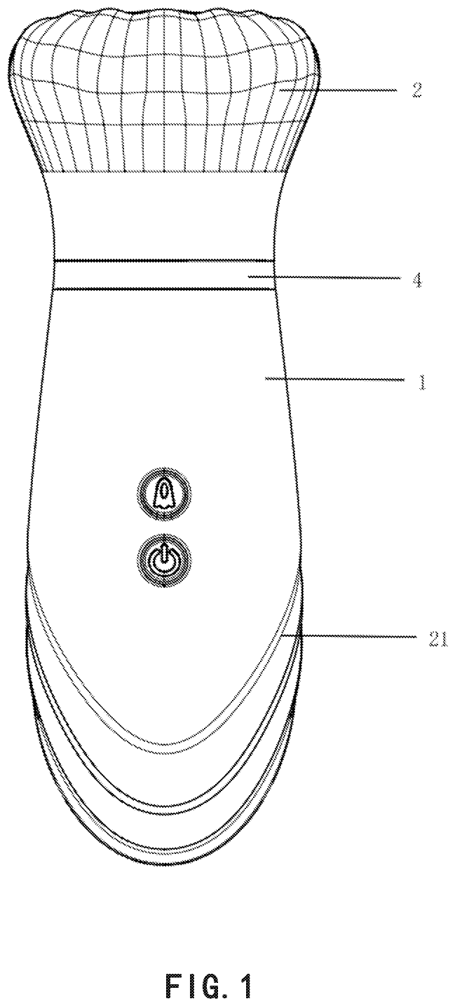

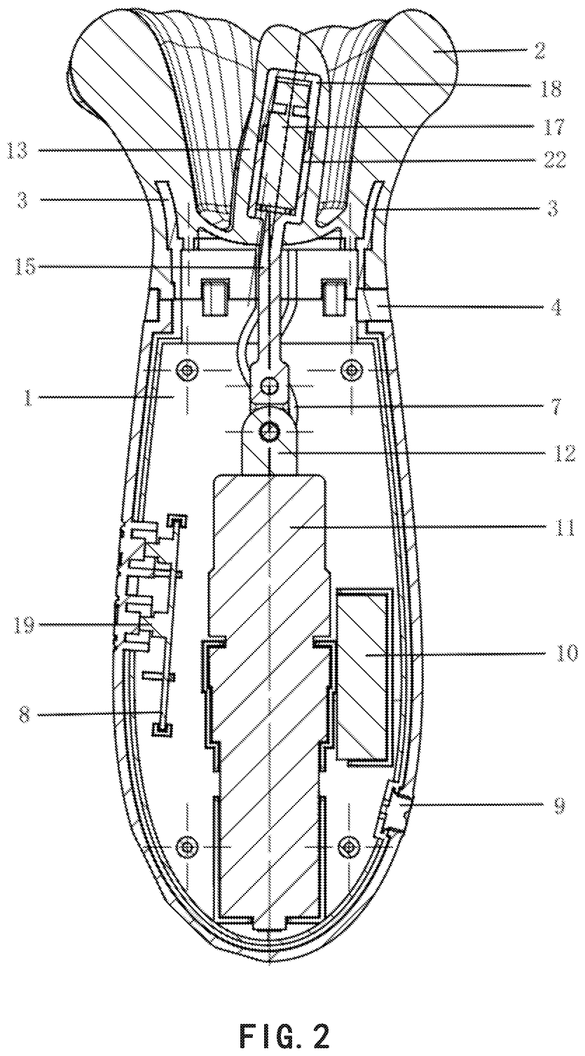

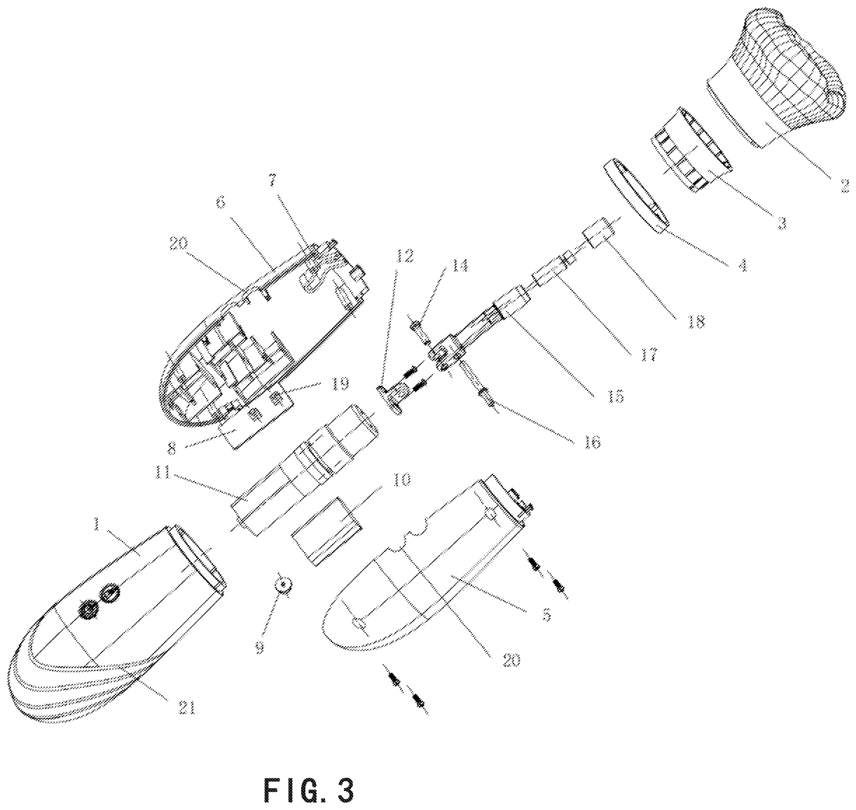

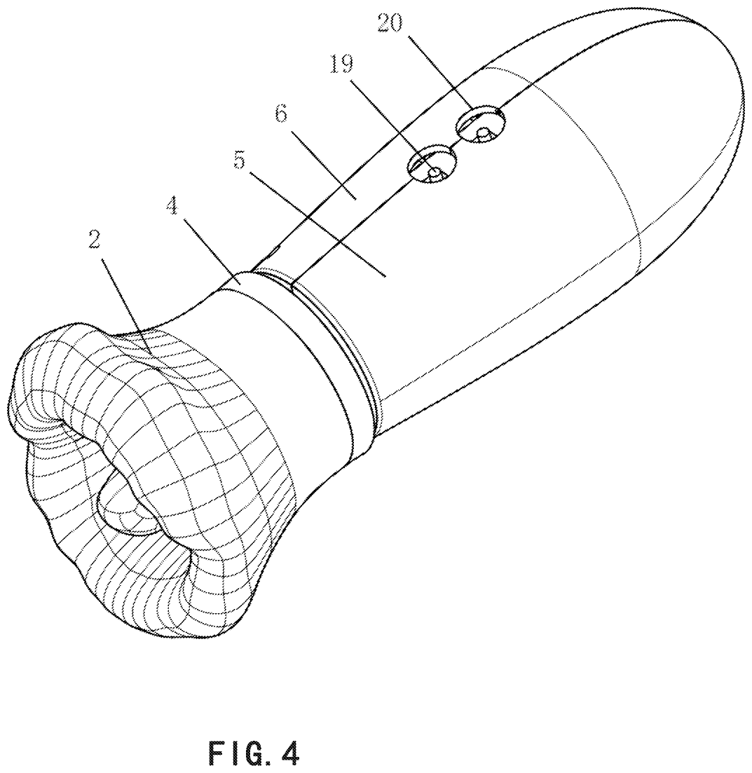

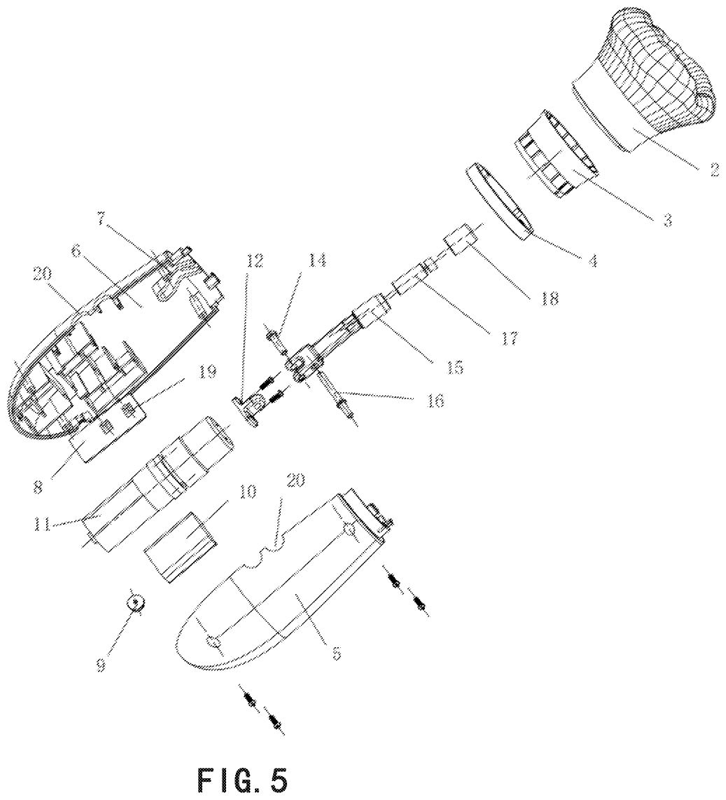

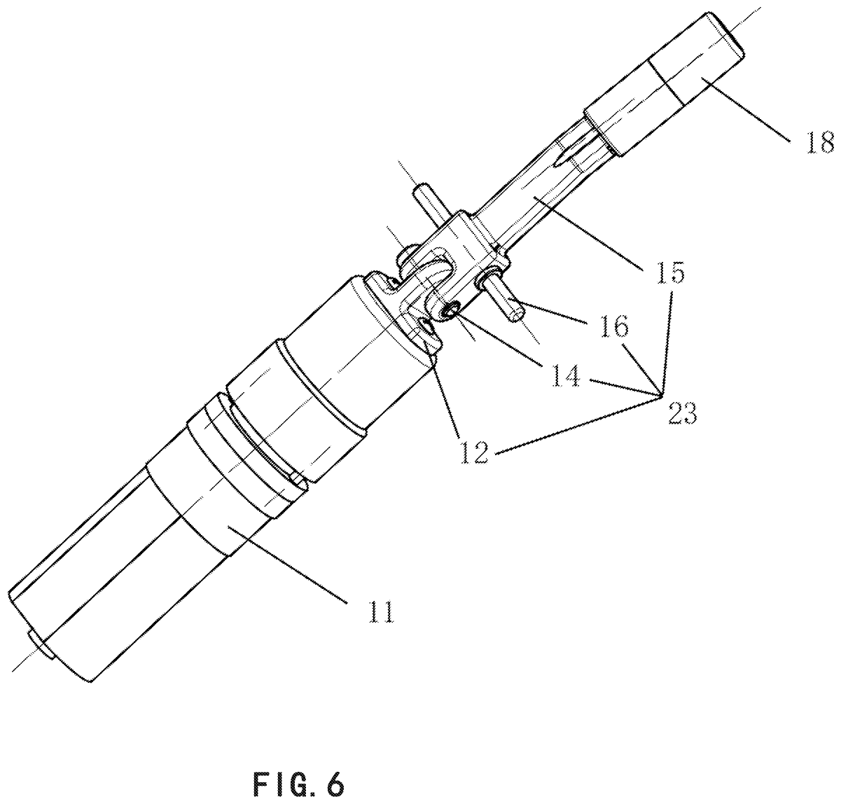

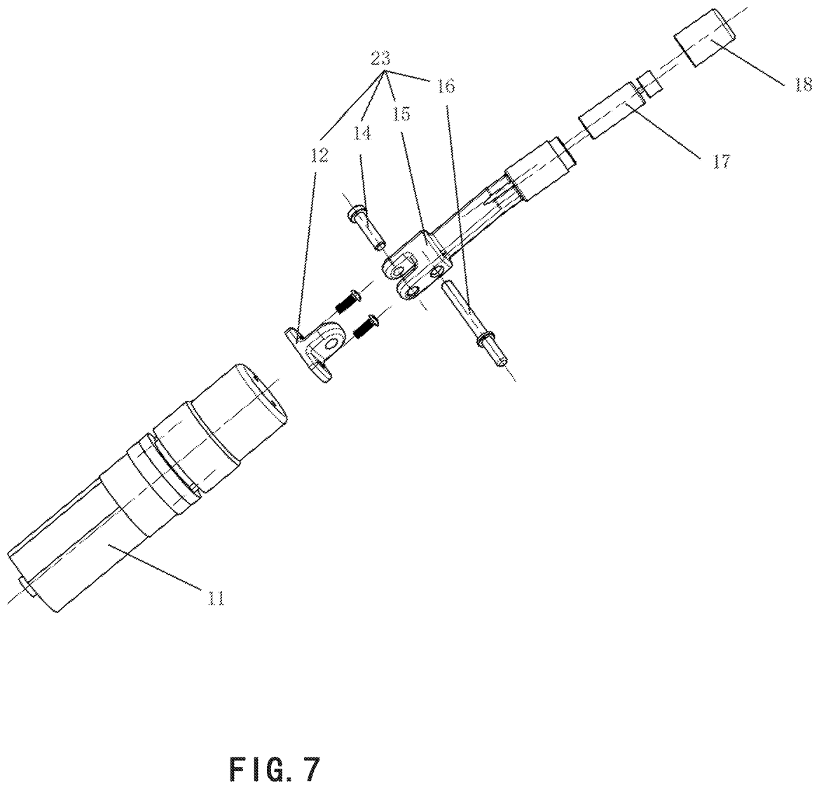

As shown in FIG. 1 to FIG. 7, a massage device with vibration, stretching, and swinging functions of the present disclosure includes a shell. One end of the shell is fixedly provided with a soft simulation member 2.

A battery 10, a stretching motor component 11, a PCB 8, and a swinging device 23 are fixedly mounted inside the shell.

The swinging device 23 includes a connector 12, a swinging member 15, a rivet shaft 14, and a guide rail shaft 16; the connector 12 is fixedly mounted at an output shaft of the stretching motor component 11 through a screw; the swinging member 15 is mounted on the connector 12 through the rivet shaft 14 in a running fit manner; the guide rail shaft 16 is fixedly mounted on the swinging member 15; guide rail slots 7 are formed in two sides in the shell; two ends of the guide rail shaft 16 are respectively mounted in the guide rail slots 7 in a sliding fit manner.

A vibration motor 17 is fixedly mounted at one end of the swinging member 15 away from the connector 12; a mounting slot 13 is formed in the middle of one side of the soft simulation member 2 close to the shell; and the vibration motor 17 is fixedly mounted in the mounting slot 13.

The battery 10 controls the stretching motor component 11 and the vibration motor 17 to work through the PCB 8.

The principle is as follows: When the stretching motor component 11 works, the swinging device 23 can be driven to do stretching movement. With the running fit between the connector 12 and the swinging member 15, the swinging member 15 can swing up and down and stretch. At this time, the two ends of the guide rail shaft 16 may slide in the guide rail slots 7 to achieve a motion along a predetermined path. In addition, by the arrangement of the vibration motor 17, a vibration effect can be provided for the soft simulation member 2, so that the soft simulation member 2 can integrate swinging, stretching, and vibration to ensure the massage experience of the device. The massage device can be used for women with sexual dysfunction, such as sexual apathy and anorgasmia and can also be used for postpartum care and postpartum repair of women. Compared with the existing product, the massage device has a better use experience and has a simple structure and low design cost, and the production efficiency and production yield of the product are improved.

Further, the two guide rail slots 7 in the shell are symmetrically arranged with each other; the two guide rail slots 7 are of wavy structures; and the swinging member 15 swings up and down through cooperation of the guide rail shaft 16 in the guide rail slots 7. The swinging member 15 can move along the wavy guide rail slots 7 serving as a preset motion path, so that the soft simulation member 2 stretches and swings more stably.

Further, the shell includes a first hard inner shell 5, a second hard inner shell 6, and a soft outer skin 1; the first hard inner shell 5 and the second hard inner shell 6 are mounted and fixed by screws; and the soft outer skin 1 is covered and mounted at outer sides of the first hard inner shell 5 and the second hard inner shell 6. The soft outer skin 1 can be used for achieving waterproofing and also has the skin-friendly characteristic, so that the use experience is enhanced.

Further, the PCB 8 is embedded with one or more control buttons 19; one or more avoidance slots 20 are formed in the first hard inner shell 5 and the second hard inner shell 6; the control buttons 19 are arranged in the avoidance slots 20 in a one-to-one correspondence and clearance fit manner; and the soft outer skin 1 is arranged in a manner of covering the avoidance slots 20. The control buttons 19 can be used to control the device to be turned on or turned off, or to control the device to switch a working frequency, so that the use experience is better.

Further, the soft outer skin 1 is made of solid silica gel.

Further, one or more anti-skid edges 21 are formed on an outer side of the soft outer skin 1. It can be convenient for holding for use.

Further, a hard reinforcing member 3 is arranged on one side of the soft simulation member 2 close to the shell, and the hard reinforcing member 3 is fixedly mounted between the shell and the soft simulation member 2. The soft simulation member 2 is mounted more firmly, and the service life is prolonged.

Further, a decorative ring 4 is sleeved and mounted on an outer side of the hard reinforcing member 3, and the decorative ring 4 is matched and mounted between the shell and the soft simulation member 2. This can achieve a decorative effect.

Further, a magnetic charging component 9 is embedded on the shell, and the magnetic charging component 9 charges the battery 10 through the PCB 8. The device is waterproof, and normal charging will not be affected.

Further, a motor slot 22 is formed at one end of the swinging member 15 away from the connector 12; the vibration motor 17 is fixedly mounted in the motor slot 22; an end cover 18 is fixedly mounted at an end portion of the swinging member 15; the end cover 18 covers the vibration motor 17 in the motor slot 22; and one end of the swinging member 15 away from the connector 12 and the end cover 18 are both mounted in the mounting slot 13 of the soft simulation member 2 in a clearance fit manner. This can effectively protect the vibration motor 17 and prevent the vibration motor 17 from being damaged.

This embodiment does not impose any formal limitations on the shape, material, structure, and the like of the present disclosure. Any simple modifications, equivalent changes, or embellishments made to the above embodiments according to the technical essence of the present disclosure shall all fall within the scope of protection of the technical solutions of the present disclosure.

What is claimed is:

1. A massage device with vibration, stretching, and swinging functions, comprising a shell, wherein one end of the shell is fixedly provided with a soft simulation member;
a battery, a stretching motor component, a Printed Circuit Board (PCB), and a swinging device are fixedly mounted inside the shell;
the swinging device comprises a connector, a swinging member, a rivet shaft, and a guide rail shaft; the connector is fixedly mounted at an output shaft of the stretching motor component through a screw; the swinging member is mounted on the connector through the rivet shaft in a running fit manner; the guide rail shaft is fixedly mounted on the swinging member; guide rail slots are formed in two sides in the shell; two ends of the guide rail shaft are respectively mounted in the guide rail slots in a sliding fit manner;
a vibration motor is fixedly mounted at one end of the swinging member away from the connector; a mounting slot is formed in the middle of one side of the soft simulation member close to the shell; the vibration motor is fixedly mounted in the mounting slot; and
the battery controls the stretching motor component and the vibration motor to work through the PCB.

2. The massage device with the vibration, stretching, and swinging functions according to claim 1, wherein the two guide rail slots in the shell are symmetrically arranged with each other; the two guide rail slots are of wavy structures; and the swinging member swings up and down through cooperation of the guide rail shaft in the guide rail slots.

3. The massage device with the vibration, stretching, and swinging functions according to claim 1, wherein the shell comprises a first hard inner shell, a second hard inner shell, and a soft outer skin; the first hard inner shell and the second hard inner shell are mounted and fixed by screws; and the soft outer skin is covered and mounted at outer sides of the first hard inner shell and the second hard inner shell.

4. The massage device with the vibration, stretching, and swinging functions according to claim 3, wherein the PCB is embedded with one or more control buttons; one or more avoidance slots are formed in the first hard inner shell and the second hard inner shell; the control buttons are arranged in the avoidance slots in a one-to-one correspondence and clearance fit manner; and the soft outer skin is arranged in a manner of covering the avoidance slots.

5. The massage device with the vibration, stretching, and swinging functions according to claim 4, wherein the soft outer skin is made of solid silica gel.

6. The massage device with the vibration, stretching, and swinging functions according to claim 5, wherein one or more anti-skid edges are formed on an outer side of the soft outer skin.

7. The massage device with the vibration, stretching, and swinging functions according to claims 6, wherein a hard reinforcing member is arranged on one side of the soft simulation member close to the shell, and the hard reinforcing member is fixedly mounted between the shell and the soft simulation member.

8. The massage device with the vibration, stretching, and swinging functions according to claim 7, wherein a decorative ring is sleeved and mounted on an outer side of the hard reinforcing member, and the decorative ring is matched and mounted between the shell and the soft simulation member.

9. The massage device with the vibration, stretching, and swinging functions according to claim 1, wherein a magnetic charging component is embedded on the shell, and the magnetic charging component charges the battery through the PCB.

10. The massage device with the vibration, stretching, and swinging functions according to claim 1, wherein a motor slot is formed at one end of the swinging member away from the connector; the vibration motor is fixedly mounted in the motor slot; an end cover is fixedly mounted at an end portion of the swinging member; the end cover covers the vibration motor in the motor slot; and one end of the swinging member away from the connector and the end cover are both mounted in the mounting slot of the soft simulation member in a clearance fit manner.
